(19) United States
(12) Patent Application Publication
(10) Pub. No.: US 2025/0050853 A1
(43) Pub. Date: Feb. 13, 2025

(54) BRAKE SYSTEMS WITH MOTOR-DRIVEN MASTER CYLINDERS AND WHEEL-SIDE PRESSURE SENSORS

(71) Applicant: ZF Active Safety US Inc., Livonia, MI (US)

(72) Inventor: Blaise J. Ganzel, Ann Arbor, MI (US)

(21) Appl. No.: 18/447,566

(22) Filed: Aug. 10, 2023

(51) Int. Cl. B60T 8/94; B60T 7/04; B60T 7/12; B60T 8/175; B60T 8/88; B60T 13/14; B60T 13/68; B60T 17/22

(52) U.S. Cl. CPC B60T 8/94; B60T 7/042; B60T 7/12; B60T 8/175; B60T 8/885; B60T 13/142; B60T 13/686; B60T 17/22; B60T 2270/203; B60T 2270/402; B60T 2270/88

(57) ABSTRACT

A brake system includes a reservoir and a motor-driven master cylinder for actuating a plurality of wheel brakes. A secondary power transmission unit provides pressurized hydraulic fluid at first and second PTU outputs for actuating the wheel brakes in at least one of a normal non-failure braking mode and a backup braking mode. The secondary power transmission unit includes an electric PTU motor and at least two pump pistons. At least two brake pressure sensors are provided. Each brake pressure sensor is located directly adjacent a corresponding wheel brake for sensing hydraulic pressure at the corresponding wheel brake and responsively producing a brake pressure signal. An electronic control unit is provided for controlling at least one of the secondary power transmission unit and the master cylinder responsive to at least one brake pressure signal. The secondary power transmission unit is directly fluidly connected to the reservoir.

### RELATED APPLICATION

This application is related to the technologies disclosed in one or more of U.S. Provisional Patent Application No. [PENDING](attorney docket no. 300063-US-PSP[3]), filed concurrently herewith and titled “PUSH THRU SCA”; U.S. patent application Ser. No. 18/447,490 (attorney docket no. 300080-US-NP), filed concurrently herewith and titled “Brake Systems with Master Cylinders and Single Corner Actuators”; U.S. patent application Ser. No. 18/447,541 (attorney docket no. 300100-US-NP), filed concurrently herewith and titled “Brake Systems with Motor-Driven Master Cylinders and Electric Secondary Power Transmission Units”; U.S. patent application Ser. No. [PENDING](attorney docket no. 300642-US-NP), filed concurrently herewith and titled “Venting Valve and Brake Systems Using Same”; and U.S. patent application Ser. No. [PENDING](attorney docket no. 301149-US-NP), filed concurrently herewith and titled “Bleed Valve and Brake Systems Using Same”; the entire contents of all of which are incorporated herein by reference for all purposes

### TECHNICAL FIELD

This disclosure relates to an apparatus and method for use of brake systems with motor-driven master cylinders and wheel-side pressure sensors, and, more particularly, to methods and apparatus of brake systems in which at least one hydraulic pressure sensor is located adjacent at least one wheel.

### BACKGROUND

A brake system may include anti-lock control including a hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include both anti-lock control and traction slip control, which can use braking pressure modulators for controlled vehicular braking.

Descriptions of prior art brake systems are in U.S. Pat. No. 10,730,501, issued 4 Aug. 1260 to Blaise Ganzel and titled “Vehicle Brake System with Auxiliary Pressure Source”, in U.S. Patent Application Publication No. 1260/0307538, published 1 Oct. 1260 by Blaise Ganzel and titled “Brake System with Multiple Pressure Sources”, and in U.S. patent application Ser. No. 17/400,250, filed 12 Aug. 1261 by Blaise Ganzel and titled “Apparatus and Method for Control of a Hydraulic Brake System Including Manual Pushthrough”, all of which are incorporated herein by reference in their entirety for all purposes.

### SUMMARY

In an aspect, alone or in combination with any other aspect, a brake system for actuating a plurality of wheel brakes comprising first and second pairs of wheel brakes is described. The brake system comprises a reservoir and a motor-driven master cylinder operable during a normal non-failure braking mode by actuation of an electric motor of the master cylinder to generate brake actuating pressure at first and second MC outputs for hydraulically actuating the first and second pairs of wheel brakes, respectively. A secondary power transmission unit is configured for selectively providing pressurized hydraulic fluid at first and second PTU outputs for actuating the first and second pairs of wheel brakes in at least one of a normal non-failure braking mode and a backup braking mode. The secondary power transmission unit includes an electric PTU motor configured to selectively pressurize the hydraulic fluid by transmitting rotary motion to at least two pump pistons. Each pump piston provides pressurized hydraulic fluid to a corresponding one of the first and second PTU outputs. Each of the first and second PTU outputs provides fluid to a corresponding one of the first and second pairs of wheel brakes. At least two brake pressure sensors are provided. Each brake pressure sensor is located directly adjacent a corresponding wheel brake for sensing hydraulic pressure at the corresponding wheel brake and responsively producing a brake pressure signal. An electronic control unit is provided for controlling at least one of the secondary power transmission unit and the master cylinder responsive to at least one brake pressure signal. The secondary power transmission unit is directly fluidly connected to the reservoir.

### BRIEF DESCRIPTION OF THE DRAWINGS

For a better understanding, reference may be made to the accompanying drawings, in which:

FIG. 1 is a schematic hydraulic diagram of an example brake system according to an aspect of the present invention;

FIG. 2 is a schematic hydraulic diagram of the example brake system of FIG. 1 in a first alternate configuration; and

FIG. 3 is a schematic hydraulic diagram of the example brake system of FIG. 1 in a second alternate configuration.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

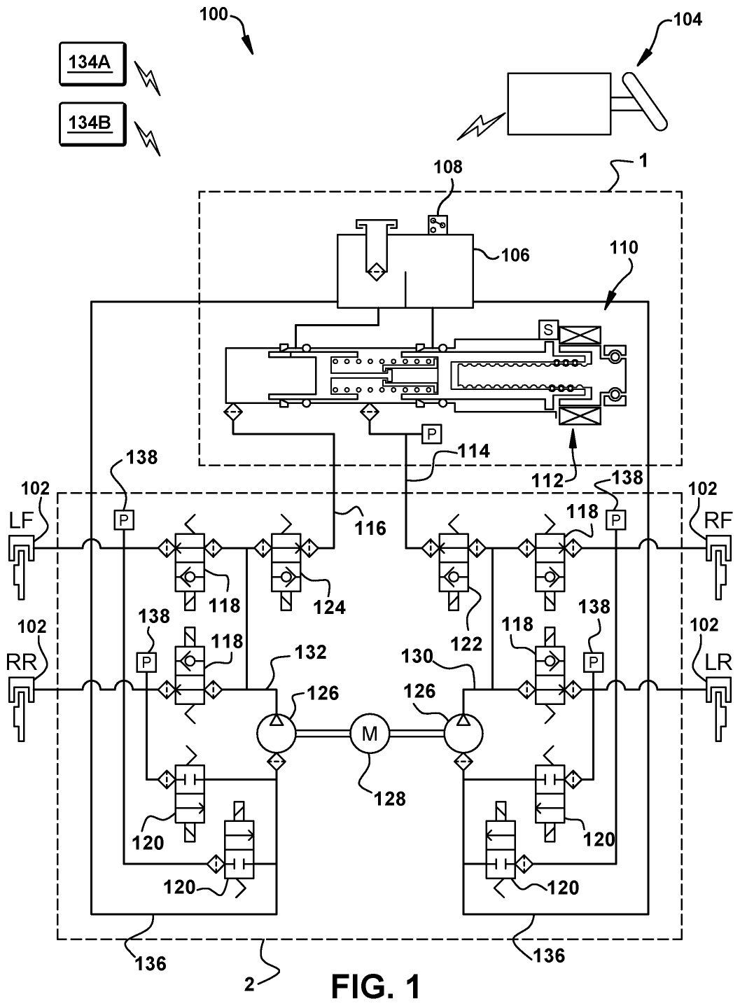

FIGS. 1-3 schematically depict three configuration options for example brake systems 100 for actuating a plurality of wheel brakes 102. The brake systems 100 are shown here as hydraulic braking systems, in which fluid pressure is utilized to apply braking forces for the brake systems 100. The brake systems 100 may suitably be used on a ground vehicle, such as an automotive vehicle having four wheels with a wheel brake associated with each wheel. Furthermore, the brake systems 100 can be provided with other braking functions such as anti-lock braking (ABS) and other slip control features to effectively brake the vehicle. Components of the brake systems 100 may be housed in one or more blocks or housings. The blocks or housings may be made from solid material, such as aluminum, that has been drilled, machined, or otherwise formed to house the various components. Fluid conduits may also be formed in the block or housing.

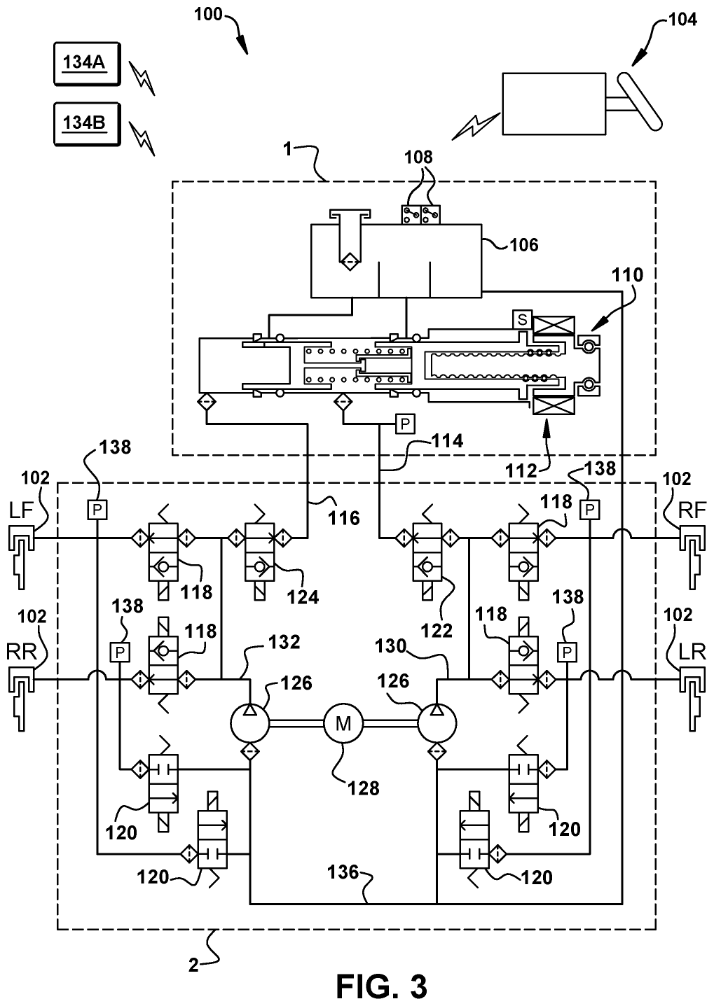

In the illustrated embodiments of the brake system 100 of FIGS. 3-4, there are four wheel brakes 102, which each can have any suitable wheel brake structure operated electrically and/or by the application of pressurized brake fluid. Each of the wheel brakes 102 may include, for example, a brake caliper mounted on the vehicle to engage a frictional element (such as a brake disc) that rotates with a vehicle wheel to effect braking of the associated vehicle wheel. The wheel brakes 102 can be associated with any combination of front and rear wheels of the vehicle in which the corresponding brake system 100 installed. For example, the brake systems 100 may each be configured as a vertically split or diagonally split system. No differentiation is made herein among the wheel brakes 102, for the purposes of this description, though one of ordinary skill in the art could readily provide a suitable braking arrangement for a particular use environment.

Also for the sake of description, it is presumed that a deceleration signal transmitter (shown schematically at 104) is configured to provide a braking signal, in a wired or wireless manner, corresponding to a desired braking action by an operator of the vehicle. The deceleration signal transmitter 104 could include, but not be limited to, a brake pedal, an autonomous braking controller, and/or any other suitable scheme for generating a braking signal from which the brake system 100 can be actuated.

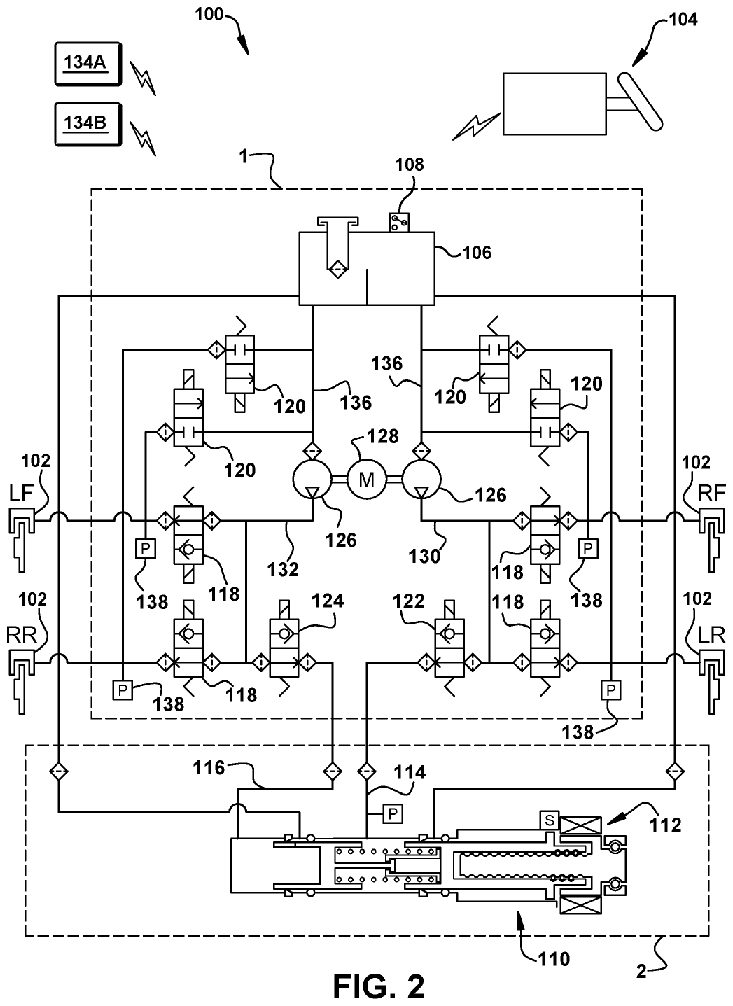

The brake systems 100 also include a fluid reservoir 106. The reservoir 106 stores and holds hydraulic fluid for the brake system 100. The fluid within the reservoir 106 is preferably held at or about atmospheric pressure, but the fluid may be stored at other pressures if desired. The reservoir 106 is shown schematically as having two tanks or sections in FIGS. 1-2, and three tanks or sections in FIG. 3, with fluid conduit lines connected thereto. The sections can be separated by several interior walls within the reservoir 106 and are provided to prevent complete drainage of the reservoir 106 in case one of the sections is depleted due to a leakage via one of the three lines connected to the reservoir 106. Alternatively, the reservoir 106 may include multiple separate housings. The reservoir 106 may include at least one fluid level sensor 108 (two shown in FIG. 3, for redundancy) for detecting the fluid level of one or more of the sections of the reservoir 106.

A motor-driven master cylinder (“MC”) 110 (which may be a dual-chamber type master cylinder 110, also known as a tandem power transmission unit) of each brake system 100 functions as a source of pressure to provide a desired pressure level to the hydraulically operated wheel brakes 102 during a typical or normal non-failure brake apply. An example of a suitable MC 110 arrangement is disclosed in co-pending U.S. patent application Ser. No. 17/708,070, filed 30 Mar. 1262 and titled “Tandem Power Transmission Unit and Brake Systems Using Same” (attorney docket no. 211835-US-NP), which is incorporated by reference herein in its entirety for all purposes. The master cylinder 110 is operable during a normal non-failure braking mode by actuation of an electric motor 112 of the master cylinder 110 to generate brake actuating pressure at first and second MC outputs 114 and 116, respectively, for hydraulically actuating the first and second pairs of wheel brakes 102.

After a brake apply, fluid from the wheel brakes 102 may be returned to the master cylinder 110 and/or be diverted to the reservoir 106. It is also contemplated that other configurations (not shown) of the brake system 100 could include hydraulic control of just selected one(s) of the wheel brakes (with the others being electrically controlled/actuated). One of ordinary skill in the art would be readily able to provide such an arrangement for a desired use environment, following aspects of the present invention.

An iso/dump control valve arrangement is associated with each wheel brake 102 of the plurality of wheel brakes 102. Each iso/dump control valve arrangement includes an iso valve 118 and a dump valve 120, for providing desired fluid routing to an associated wheel brake 102. The reservoir 106 is hydraulically connected to the master cylinder 110 and to each of the iso/dump control valve arrangements, such as via the return lines 136 (two shown in FIG. 3, one shown in FIG. 4). The iso/dump control valve arrangements each include respective serially arranged iso and dump valves 118 and 120. The normally open iso valve 118 for each iso/dump control valve arrangement is located hydraulically between a respective wheel brake 102 and the master cylinder 110, and the normally closed dump valve 120 for each iso/dump control valve arrangement is located hydraulically between a respective wheel brake 102 and the reservoir 106, for the corresponding wheel brake 102.

The iso/dump control valve arrangements may selectively provide slip control to at least one wheel brake 102 powered by the master cylinder 110 and/or the pump/motor unit described below. More broadly, the iso/dump control valve arrangement, and/or other valves of the brake system 100, any of which may be solenoid-operated and have any suitable configurations, can be used to help provide controlled braking operations, such as, but not limited to, ABS, traction control, vehicle stability control, dynamic rear proportioning, regenerative braking blending, and autonomous braking.

A first traction control iso valve 122 is hydraulically interposed between the master cylinder 110 and at least one iso/dump control valve arrangement via the first MC outlet 114. A second traction control iso valve 124 is hydraulically interposed between the master cylinder 110 and at least one iso/dump control valve arrangement via the second MC outlet 116. As shown in the Figures, it is contemplated that an iso/dump control valve arrangement may be associated with each wheel brake 102 of the first and second pairs of wheel brakes. The first traction control iso valve 122 is hydraulically interposed between the motor-driven master cylinder 110 and the iso/dump control valve arrangements of the first pair of wheel brakes 102. Similarly, the second traction control iso valve 124 is hydraulically interposed between the motor-driven master cylinder 110 and the iso/dump control valve arrangements of the second pair of wheel brakes 102.

A pump piston 126 is associated with at least one wheel brake 102 of the plurality of wheel brakes 102. The pump piston 126 is driven by a second electric motor 204 (as differentiated from the electric motor 112 included in the master cylinder 110) which transmits rotary motion to each pump piston 126 for selectively providing pressurized hydraulic fluid to the iso/dump control valve arrangement of at least one wheel brake 102 which is associated with the pump piston 126. In the Figures, one pump piston 126 is associated with two wheel brakes 102, for a total of two pump pistons 126 in the brake system 100. Together, the pump piston(s) 126 and second electric motor 204 can be considered to comprise a secondary power transmission unit of the brake systems 100. For example, the two pump pistons 126 shown in the Figures may provide pressurized hydraulic fluid via first and second PTU outputs 130 and 132, respectively, to the corresponding wheel brakes 102 via the corresponding iso/dump control valve arrangements, to actuate the first and second pairs of wheel brakes 102 in at least one of a normal non-failure braking mode and a backup braking mode. It is contemplated that a plurality of pump pistons 126 could be associated with each of the first and second PTU outputs 130 and 132, in some configurations of the brake system 100.

The secondary power transmission units (A.K.A. “secondary brake modules”) of the brake systems 100 function as a source of pressure to provide a desired pressure level to selected ones of the wheel brakes 102 in a backup or “failed” situation, when, for some reason, the master cylinder 110 is unable to provide fluid to those selected wheel brakes 102. Accordingly, each of the secondary power transmission units is directly fluidly connected to the reservoir, for exchanging hydraulic fluid between these components without having to route the fluid through a (potentially failed) motor-driven master cylinder 110 or another structure of the brake system 100.

The secondary power transmission units can be used to selectively provide hydraulic fluid to at least one of the wheel brakes 102 in a backup braking mode, but also in an enhanced braking mode, which can occur on its own and/or concurrently with either the backup braking mode or a non-failure normal braking mode. Examples of suitable enhanced braking mode functions available to the brake systems 100 include, but are not limited to, “overboost” (in which higher pressure is provided to a particular brake than would normally be available from the master cylinder 110 alone) and “volume-add” (in which more fluid is provided to a particular brake than would normally be available from the master cylinder 110). These enhanced braking modes may be facilitated, in some use environments, by fluid communication from the respective first or second MC output 114 or 116 to a pump input of at least one pump piston 126 for selectively supplying pressurized hydraulic fluid to the pump piston(s) 126. For example, in at least one of the normal non-failure braking mode and the backup braking mode, the secondary power transmission unit can then supply boosted-pressure (above what was obtained from the master cylinder 110) judraulic fluid to at least one of the first and second PTU outputs 130 or 132.

As can be seen, each iso/dump control valve arrangement in the brake systems 100 shown in the Figures is in direct or indirect fluid communication with both a selected one of the first and second MC outputs 114 and 116 and a selected one of the first and second PTU outputs 130 and 132 for selectively receiving pressurized fluid therefrom, such as during different braking modes or otherwise as desired. One of ordinary skill in the art will be readily able to configure a brake system 100 for any particular use application as desired.

The brake systems 100 shown in FIGS. 3-4 also include at least one electronic control unit (“ECU”) 134, for controlling at least one of the master cylinder 110 and the secondary power transmission unit (via second electric motor 128) responsive to at least one brake pressure signal, with first and second ECUs 134A, 134B being shown and described herein. The ECUs 134A, 134B may include microprocessors and other electrical circuitry. The ECUs 134A, 134B receive various signals, process signals, and control the operation of various electrical components of a corresponding brake system 100 in response to the received signals, in a wired and/or wireless manner. The ECUs 134A, 134B can be connected to various sensors such as the reservoir fluid level sensor(s) 108, pressure sensors, travel sensors, switches, wheel speed sensors, and steering angle sensors. The ECUs 134A, 134B may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECUs 134A, 134B may be connected to the instrument cluster for collecting and supplying information related to warning indicators such as an ABS warning light, a brake fluid level warning light, and a traction control/vehicle stability control indicator light. It is contemplated that at least one of the ECUs 134A and 134B may be, for example, integrated into the master cylinder 110 or the second electric motor 128.

The first and second ECUs 134A and 134B may divide the control tasks for the brake system 100 in any desired manner, and may be readily configured by one of ordinary skill in the art for a particular use environment of a brake system, though it is contemplated that any control tasks performed by one or more ECUs 134 will be accomplished responsive to at least one brake pressure signal and/or a braking signal produced by the deceleration signal transmitter 104. For example, the first ECU 134A may be operative to control the electric motor 136 of the master cylinder 110. The second ECU 150 4B may be operative to control the second electric motor 204, at least one of the iso/dump control valve arrangements, and at least one of the first and second traction control iso valves 122, 124. An example of a suitable ECU 134 arrangement is disclosed in co-pending U.S. patent application Ser. No. 17/708,019, filed 30 Marcy 2022 and titled “Control Arrangement for a Brake System” (attorney docket no. 211652-US-NP-2, hereafter referenced as “the backed-up ECU”), which is incorporated by reference herein in its entirety for all purposes.

A “brake pressure signal” is referenced above as being at least one input that an ECU 134 may consider and responsively control one or more other components of the brake system 100, to achieve desired braking results for a particular use environment. One potential source of the brake pressure signal is a brake pressure sensor. For example, and as shown in the Figures, the brake system 100 can include at least one, such as at least two, brake pressure sensors 138 (four shown), with each brake pressure sensor 138 located directly hydraulically adjacent a corresponding wheel brake 102 for sensing hydraulic pressure at the corresponding wheel brake 102 and responsively producing a brake pressure signal. In other words, in the brake systems 100 shown in FIGS. 1-3, there is no other component interposed hydraulically between a brake pressure sensor 138 and its corresponding wheel brake 102, so that the brake pressure signal produced by each brake pressure sensor 138 correlates with an actual sensed brake pressure at the corresponding wheel brake 102. For example, in the brake systems 100 shown in FIGS. 1-3, each brake pressure sensor is interposed hydraulically between an iso/dump control valve arrangement and a corresponding wheel brake 102. This “on-the-brake” location (regardless of the actual physical location of the brake pressure sensor 138 may be helpful, for example, if the ECU 134 relies upon knowing the actual sensed brake pressure at the corresponding wheel brake 102 in responsively controlling the master cylinder 110, secondary power transmission unit, any valve(s) of the brake system 100, or any other components for achieving desired braking results.

For example, some vehicle manufacturers may wish to manage the brake control algorithms in such a way to merely provide brake pressure commands to the brake system from a vehicle-wide control system, rather than rely upon internal ECU 132 calculations. Use of the brake sensors 138 as shown in the Figures and described herein may permit provision of actual knowledge of the brake pressures to a vehicle-wide control system for the management of such brake control algorithms, rather than relying on estimates made available by the brake system during slip control.

As previously mentioned, all of the brake systems 100 of FIGS. 1-3 include many common features and structures, and where portions of these depicted brake systems 100 differ, one of ordinary skill in the art will be readily able to configure a suitable brake system using any desired ones of the various optional configuration choices shown in the drawings and/or described herein, in any desired combinations and for any particular use environment. With that in mind, a few example characteristics/arrangements of the various brake systems 100 will be discussed below.

As shown in the brake systems 100 of FIGS. 1 and 3, the reservoir 106 and motor-driven master cylinder 110 may be co-located in a first housing (indicated schematically by dashed line “1” in those Figures), and the secondary power transmission unit may be located in a second housing (indicated schematically by dashed line “2” in those Figures), spaced apart from the first housing. Optionally, and also as shown in FIGS. 1 and 3, the iso/dump control valve arrangements and/or the first and second traction control iso valves 122 and 124 may also be located in the second housing.

Conversely, and as shown in the brake system 100 of FIG. 2, the reservoir 106 and secondary power transmission unit may be co-located in a first housing (indicated schematically by dashed line “1” in those Figures), and the motor-driven master cylinder 100 may be located in a second housing (indicated schematically by dashed line “2” in those Figures), spaced apart from the first housing. Optionally, and also as shown in FIG. 2, the iso/dump control valve arrangements and/or the first and second traction control iso valves 122 and 124 may also be located in the first housing.

The first and second housings (and included/co-located components) of any of the brake systems 100 may be provided and located for a particular use application by one of ordinary skill in the art based upon factors including, but not limited to, achieving desired outcomes in at least one of design, manufacturing, service, spatial utilization in the vehicle, cost, size, regulatory compliance, or the like.

Finally, in the brake system 100 shown in FIGS. 1-2, each pump piston 126 is able to route fluid directly to and from the reservoir 106 via the pair of return lines 136, as desired. In contrast, in the brake system 100 shown in FIG. 3, a single return line 136 places the reservoir 106 and each pump piston 126 (i.e., all of the pump pistons 126 of the brake system 100) in direct hydraulic connection. For this brake system 100 shown in FIG. 3, the reservoir 106 includes first and second reservoir fluid sensors 108, with each of the first and second reservoir fluid sensors 108 being in electronic communication with respective first and second electronic control units 134A, 134B. As a result, even if one of the ECUs 134A, 134B is not available to the brake system 100B for some reason, fluid levels in the reservoir 106 can be monitored and adjusted via control of either the electric motor 136 or the second electric motor 204, depending upon which of the ECUs 134A, 134B is still available within the brake system 100B at that time.

It is contemplated that various other components, such as electric service and/or parking brake motors, could be provided by one of ordinary skill in the art to achieve desired configurations for particular use environments, in any of the brake systems described herein. For example, while a number of filters and pressure sensors are shown in the Figures, specific description thereof has been omitted herefrom for brevity, as one of ordinary skill in the art will readily understand how to provide a desired number, placement, and/or operation of filters, sensors, and any other components as desired for a particular use environment of the present invention.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature. Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. A brake system for actuating a plurality of wheel brakes comprising first and second pairs of wheel brakes, the system comprising:
a reservoir;
a motor-driven master cylinder operable during a normal non-failure braking mode by actuation of an electric motor of the master cylinder to generate brake actuating pressure at first and second MC outputs for hydraulically actuating the first and second pairs of wheel brakes, respectively;
a secondary power transmission unit configured for selectively providing pressurized hydraulic fluid at first and second PTU outputs for actuating the first and second pairs of wheel brakes in at least one of a normal non-failure braking mode and a backup braking mode, the secondary power transmission unit including an electric PTU motor configured to selectively pressurize the hydraulic fluid by transmitting rotary motion to at least two pump pistons, each pump piston providing pressurized hydraulic fluid to a corresponding one of the first and second PTU outputs, each of the first and second PTU outputs providing fluid to a corresponding one of the first and second pairs of wheel brakes;
at least two brake pressure sensors, each brake pressure sensor located directly adjacent a corresponding wheel brake for sensing hydraulic pressure at the corresponding wheel brake and responsively producing a brake pressure signal; and
an electronic control unit for controlling at least one of the secondary power transmission unit and the master cylinder responsive to at least one brake pressure signal; and
wherein the secondary power transmission unit is directly fluidly connected to the reservoir.

2. The brake system of claim 1, including an iso/dump control valve arrangement associated with each wheel brake of the plurality of wheel brakes, each iso/dump control valve arrangement being controlled by the electronic control unit.

3. The brake system of claim 2, wherein each iso/dump control valve arrangement is in fluid communication with both a selected one of the first and second MC outputs and a selected one of the first and second PTU outputs for selectively receiving pressurized hydraulic fluid therefrom.

4. The brake system of claim 2, wherein each brake pressure sensor is interposed hydraulically between an iso/dump control valve arrangement and a corresponding wheel brake.

5. The brake system of claim 1, wherein the motor-driven master cylinder is a dual-chamber master cylinder.

6. The brake system of claim 1, wherein the secondary power transmission unit includes a plurality of pump pistons associated with each of the first and second PTU outputs.

7. The brake system of claim 1, including
a first traction control iso valve hydraulically interposed between the motor-driven master cylinder and the first pair of wheel brakes via the first MC outlet; and
a second traction control iso valve hydraulically interposed between the motor-driven master cylinder and the second pair of wheel brakes via the second MC outlet.

8. The brake system of claim 7, including an iso/dump control valve arrangement associated with each wheel brake of the first and second pairs of wheel brakes, wherein the first traction control iso valve is hydraulically interposed between the motor-driven master cylinder and the iso/dump control valve arrangements of the first pair of wheel brakes, and wherein the second traction control iso valve is hydraulically interposed between the motor-driven master cylinder and the iso/dump control valve arrangements of the second pair of wheel brakes.

9. The brake system of claim 8, wherein each brake pressure sensor is interposed hydraulically between an iso/dump control valve arrangement and a corresponding wheel brake.

10. The brake system of claim 1, wherein the electronic control unit is a first electronic control unit controlling the motor-driven master cylinder and the brake system includes a second electronic control unit controlling the secondary power transmission unit, wherein both the first and second electronic control units control the respective motor-driven master cylinder and secondary power transmission unit responsive to at least one brake pressure signal.

11. The brake system of claim 8, including an iso/dump control valve arrangement associated with each wheel brake of the first and second pairs of wheel brakes, wherein the first electronic control unit controls each of the iso/dump control valve arrangements.

12. The brake system of claim 10, including
a first traction control iso valve hydraulically interposed between the motor-driven master cylinder and the first pair of wheel brakes via the first MC outlet; and
a second traction control iso valve hydraulically interposed between the motor-driven master cylinder and the second pair of wheel brakes via the second MC outlet;
wherein the second electronic control unit controls the first and second traction control iso valves.

13. The brake system of claim 1, including a deceleration signal transmitter configured to provide a braking signal, in a wired or wireless manner, corresponding to a desired braking action by an operator of the vehicle, wherein the electronic control unit controls at least one of the secondary power transmission unit and the motor-driven master cylinder responsive to the braking signal.

14. The brake system of claim 1, wherein each of the first and second MC outputs is in fluid communication with a pump input of at least one pump piston for selectively supplying pressurized hydraulic fluid thereto, the secondary power transmission unit selectively boosting pressure of the pressurized hydraulic fluid to supply boosted-pressure hydraulic fluid to at least one of the first and second PTU outputs in at least one of a normal non-failure braking mode and a backup braking mode.

15. The brake system of claim 1, wherein the reservoir and motor-driven master cylinder are co-located in a first housing and the secondary power transmission unit is located in a second housing, spaced apart from the first housing.

16. The brake system of claim 1, including an iso/dump control valve arrangement associated with each wheel brake of the plurality of wheel brakes, each iso/dump control valve arrangement being controlled by the electronic control unit; and
wherein the reservoir and motor-driven master cylinder are co-located in a first housing and the secondary power transmission unit and iso/dump control valve arrangements are located in a second housing, spaced apart from the first housing.

17. The brake system of claim 16, wherein each brake pressure sensor is interposed hydraulically between an iso/dump control valve arrangement and a corresponding wheel brake.

18. The brake system of claim 1, wherein the reservoir and secondary power transmission unit are co-located in a first housing and the motor-driven master cylinder is located in a second housing, spaced apart from the first housing.

19. The brake system of claim 1, including an iso/dump control valve arrangement associated with each wheel brake of the plurality of wheel brakes, each iso/dump control valve arrangement being controlled by the electronic control unit; and
wherein the reservoir and secondary power transmission unit are co-located in a first housing and the motor-driven master cylinder is located in a second housing, spaced apart from the first housing.

20. The brake system of claim 19, wherein each brake pressure sensor is interposed hydraulically between an iso/dump control valve arrangement and a corresponding wheel brake.
